(19) United States
(12) Patent Application Publication
(10) Pub. No.: US 2015/0299044 A1
(43) Pub. Date: Oct. 22, 2015

(54) CERAMIC MATERIAL

(71) Applicant: CERAMTEC-ETEC GMBH, Lohmar (DE)

(72) Inventors: Lars Schnetter, Wimbach (DE); Frank Wittig, Erlangen (DE)

(21) Appl. No.: 14/652,180

(22) PCT Filed: Dec. 19, 2013
(86) PCT No.: PCT/EP2013/077304

§ 371 Date: Jun. 15, 2015

(30) Foreign Application Priority Data
Dec. 19, 2012 (DE) 10 2012 223 802.6

(51) Int. Cl. C04B 35/10

(52) U.S. Cl. CPC C04B 35/10; C04B 2235/9653

(57) ABSTRACT

Raw materials containing impurities for producing transparent ceramics and methods of producing the transparent ceramics and the raw materials, as well as the transparent ceramics produced.

The invention relates to ceramic materials; in particular the invention relates to ceramic materials for producing transparent ceramics.

Transparent ceramics and their preparation are known from the prior art. DE 10 2004 004 259 B3 discloses a polycrystalline ceramic having a high mechanical strength, for example, which has a real in-line transmittance (RIT) of more than 75% of the theoretical maximum value for a 0.8 mm thick polished plate and at wavelengths between 600 and 650 nm, wherein the average grain size D is in the range between 60 nm and 10 μm.

The transparency of polycrystalline ceramic discs is influenced by various factors. Thus naturally a material must be used that has only extremely low light absorption. In addition, the transparency of polycrystalline ceramic discs substantially depends on light scattering, which results on the one hand from the crystal structure and on the other from the microstructure of the ceramic body. Materials with cubic crystal systems are preferably used, because no birefringence occurs. Furthermore, the methods for producing transparent ceramics are optimized so that the smallest possible porosity occurs, or the pore size is less than the wavelength of the light in order to minimize light scattering at the phase boundaries.

Another substantial factor in producing transparent ceramics is the use of high-purity raw materials, since even the slightest contamination of more than 100 ppm leads to white or black spots in the ceramic. Therefore generally only raw materials are used that have a purity of >99.99%, preferably even >99.9999%. However, these raw materials are very expensive.

The object of the invention is therefore to provide alternative ceramic materials that are suitable for producing transparent ceramics and are less cost-intensive than the highly pure raw materials known from the prior art.

The object is achieved by means of a ceramic material according to claim 1.This ceramic material is characterized in that it consists of metal oxides obtained by calcination of hydrotalcites. The material can preferably be used to produce transparent ceramics.

Hydrotalcites according to the invention are metal hydroxides which were prepared by a hydrotalcite method. A transparent ceramic in the sense of the invention is understood to mean a ceramic which has an RIT of at least 40% at 300 nm, 600 nm and/or 1500 nm wavelength of light. Purely theoretically, the transparency is thickness-independent if a perfect material is present and a perfect ceramic is produced therefrom. However, once the ceramic contains pores and the like, there is a scattering effect at the phase boundaries of the pores, which becomes more intense with increasing thickness of the ceramic. This effect leads to decreasing transparency. Therefore, the transparencies mentioned in this document relate to ceramics with wall thicknesses between 50 μm and 100 mm.

Particularly preferably, the hydrotalcites from which the ceramic material of the invention is obtained by calcination are produced by means of a hydrotalcite method.

Hydrotalcite methods are known from the prior art. Such a method is described in EP 0 807 086 B1, for example. A hydrotalcite method in the scope of this invention is understood to mean a method comprising at least the following steps:
provision of the metal, aluminum for example, and an alcohol, ethanol for example
conversion of metal and alcohol to a metal alcoholate, for example aluminum alcoholate, with release of hydrogen
conversion of the metal alcoholate with addition of water into metal hydroxide, boehmite for example, with release of the alcohol.

According to a particularly preferred embodiment of the invention, the metal oxides obtained by calcination from the metal hydroxides can contain between 100 and 500 ppm impurities, preferably between 100 and 200 ppm, particularly of Fe, Mn, Cr, V, Zn, Sn, Ti, Si, Zr, Ca, Na, K, Li, Y, Ni, Co, and Cu. This is particularly advantageous, because lower demands are placed on the purity of raw materials than for materials according to the prior art. Usually only raw materials with a purity of >99.99% or raw materials that have <100 ppm impurities are used. The required lower purity grade, which is not at the expense of transparency, thus allows the use of much lower-cost raw materials.

It is suspected that the higher level of impurities is possible because the contaminants are highly dispersed and very homogeneous, possibly at the atomic level, in the material. In any case they do not form a separate phase, a grain boundary phase for example, which in the sintered ceramic would result in a reduction of transparency. It is suspected that the impurities are incorporated into the lattice of the metal oxides. This means the incorporation of the metal cations in the lattice of the spinel, for example cation grids, interstitials, and the like.

It is surprising hereby that not only is no deterioration of transparency observed, but beyond that, there is also no substantial coloring of the ceramic. In particular, with the raw material according to the invention, transparent ceramics can be produced that between 300 nm and 700 nm, particularly at 300 nm and 700 nm, have a deviation in RIT-value of <10%, and thus achieve a high white level.

Metal hydroxides whose metal oxides have a cubic crystal system are preferably produced by the hydrotalcite process. In addition to the oxides, such as Al₂O₃ or MgO, spinels, in particular Mg-Al-spinels, are especially preferably produced. But there are also transparent ceramics of ZrO₂, oxides of mixtures of Y and Al as well as materials of mixtures of Al, N, O or also non-cubic aluminum oxide that can be preferably produced with this method.

In contrast to the prior art, for example DE 10 2004 004 259 B3, in using the material according to the invention, the use of sintering aids can be entirely dispensed with.

Sintering aids facilitate the use of lower sintering temperatures with less grain growth. However, the sintering aids must be at least partially expelled again by means of volatile compounds such as LiF, because otherwise they would be present as a separate phase in the ceramic, which again would have adverse effects on transparency. These additives are not necessary when using the ceramic material according to this invention for the production of transparent ceramics.

In the following the invention will be explained in more detail with reference to exemplary embodiments.

### Example 1

An MgOAl₂O₃ raw material is used with a total of 406 ppm impurities, produced by the hydrotalcite method, with the following composition (ICP analysis):

MgO: 28.9%,
Na: 18 ppm,
Si: 196 ppm,
Fe: 98 ppm,
Cr: 7 ppm,
Ti: 10 ppm,
Mn: 40 ppm,
Zn: 37 ppm,

Rest: Al₂O₃.

Specific surface area (BET): 18 m²/g, Initial grain size distribution d90: 5.5 μm, d50 2.4 μm, d10: 0.8 μm

1500 g of the raw material are stirred into 1500 g of deionized water containing 7% diammonium hydrogen citrate. The thus pre-homogenized slurry is ground with an agitator ball mill (500 μm-Al₂O₃ grinding beads) until an energy input of 1.60 kWh/kg is achieved. The following grain size distribution is then present: d90: 375 nm, d50: 224 nm, d10: 138 nm (measured with a Nanoflex measurement device from Microtrac). The specific surface area (BET) is 25.5 m²/g.

The slurry prepared in this way is mixed with 6% of a short-chain polyethylene glycol, and granulated using a spray-freeze drying method. Freeze-drying results in a press-capable granulate, from which specimens with a net green density of 2.17 g/cm³ are formed. These are presintered at 1455° C. for 2 h to 3.519 g/cm³ and then compressed at 1650° C. for 6 hours at 200 MPa by a hot-isostatic method (HIP=hot isostatic pressing).

The samples are ground and polished to 2 mm thickness for a transmittance measurement.

The following RIT values depending on the wavelength were determined: 300 nm: 74%, 600 nm: 78%, 700 nm: 80%, 1500 nm: 81%.

### Example 2

A raw material MgOAl₂O₃ is used with 232 ppm impurities, produced by the hydrotalcite-method, having the following composition (ICP analysis):

MgO: 33.9%
Na: 18 ppm
Si: 83 ppm
Fe: 71 ppm
Ca: 5 ppm
Cr: 4 ppm
Ni: 2 ppm
Ti: 18 ppm
Mn: 27 ppm
Cu: 1 ppm
Zr: 3 ppm

Rest: Al₂O₃

Specific surface area (BET): 58 m 2/g Initial grain size distribution d90: 7.85 μm, d50 3.2 μm, d10: 0.9 μm

The preparation proceeds analogously to Example 1 until an energy input of 1.05 kWh/kg is achieved. The following grain size distribution is then present: d90: 345 nm, d50: 195 nm, d10: 124 nm (measured with a Nanoflex measurement device from Microtrac), BET 23.5 m²/g.

The slurry prepared in this way is mixed with 6% of a short-chain polyethylene glycol, and granulated using a spray-freeze drying method. Freeze drying results in a press-capable granulate, from which specimens are formed with a net green density of 2.07 g/cm³. These are presintered at 1400° C. for 2 h to 3.512 g/cm³ and then compressed at 1650° C. for 6 h at 200 MPa in a hot isostatic method.

The samples are ground and polished to a thickness of 2 mm for a transmittance measurement:

The following RIT values were determined depending on the wavelength: 300 nm: 60%, 600 nm: 71%, 700 nm: 75%, 1500 nm: 77%.

### Example 3

A raw material MgOAl₂O₃ with 156 ppm of impurities is used, which was prepared according to the hydrotalcite method and has the following composition (ICP analysis):

MgO: 28.9%,
Na: 22 ppm,
Si 83 ppm,
Fe: 31 ppm,
Cr: 1 ppm,
Ca: 3 ppm,
Ti: 1 ppm,
Mn: 8ppm,
Zn: 7 ppm,

Al₂O₃: Rest.

Specific surface area (BET): 7.3 m²/g Initial grain size distribution d90: 4.7 μm, d50 2.1 μm, d10: 0.3 μm 600 g of raw material are stirred in 600 g of deionized water with 4.7% diammonium hydrogen citrate. The thus pre-homogenized slurry is ground with an agitator ball mill (500 μm-Al₂O₃ grinding beads) until an energy input of 1.5 kWh/kg is achieved. The specific surface area (BET) is then 51.3 m²/g.

The thus prepared slurry is mixed with a 5% aqueous polymer dispersion and 4% fatty acid preparation, and granulated using a spray-freeze drying method. Freeze drying results in a press-capable granulate from which specimens with a net green density of 2.18 g/cm³ are formed. These are presintered at 1550° C. for 2 h to 3.413 g/cm³ and then compressed at 1650° C. for 6 h at 200 MPa.

The samples are ground and polished to 2 mm thickness for transmittance measurement: The following RIT values were obtained depending on the wave length: 300 nm: 70%, 600 nm: 75%, 700 nm: 77%, 1500 nm: 79%.

### Example 4

### Comparison Example

A MgOAl₂O₃ raw material with 461 ppm impurities, which is not produced according to the hydrotalcite method, was used. The following composition was determined per ICP analysis:

Mg: 17.1%,

Al: 37.9%,
Na: 69 ppm,
K: 32 ppm,
Ca: 130 ppm,
Ti: 19 ppm,
V: 41 ppm,
Cr: 14 ppm,
Mn: 7 ppm,
Fe: 95 ppm,

Ni: 5 ppm,
Zn: 14 ppm,
Ga: 35 ppm,

Rest: O.

Specific surface area 22.2 m²/g.

540 g of raw material are stirred into 800 g of deionized water with 1.5% diammonium hydrogen citrate. This slurry is ground with an agitator ball mill (500 μm-Al₂O₃ grinding beads) until an energy input of 1.50 kWh/kg is achieved. The following grain size distribution is then present: d90: 234 nm, d50: 156 nm, d10: 84 nm (measured with a Nanoflex measurement device from Microtrac), BET 68.1 m²/g.

The slurry is granulated as described in Example 1 and 2. The comparably produced pellets with a net green density of 1.89 g/cm³ are presintered at 1430° C. for 2 h to 3.524 g/cm³ and then compressed at 1650° C. for 6 h at 200 MPa in a hot isostatic method.

The samples are ground and polished to 2 mm thickness for a transmittance measurement. No RIT values can be measured. The samples are opaque.

### Example 5

### Comparison Example

A MgOAl₂O₃-raw material with 60 ppm impurities is used, which is not produced by the hydrotalcite method. Conversion rate to spinel (crystalline phase determination with x-ray diffractometry) 99.5%, free alpha Al₂O₃ 0.4%, free MgO 0.1%. The following impurities were determined with ICP analysis:

Na: 15 ppm,

K: 32 ppm,

Fe: 2 ppm,

Si: 11 ppm

Rest O.

average grain size d50 (sedigraph): 0.18 μm. specific surface area (BET): 28.2 m²/g.

4000 g of raw material are stirred into 3605 g of deionized water with 2.3% diammonium hydrogen citrate. This slurry is ground with an agitator ball mill (500 μm grinding beads) until an energy input of 0.85 kWh/kg is achieved. The following grain size distribution is then present: d90: 252 nm, d50: 152 nm, d10: 101 nm (measured with a Zetasizer measurement device from Malvern), BET 31.7 m²/g.

The thus prepared slurry is mixed with 6% of a short-chain polyethylene glycol, and granulated using a spray-freeze drying method. The freeze drying results in a press-capable granulate, from which specimens with a net green density of 1.91 g/cm³ are formed. These are presintered at 1530° C. for 2 h to 3.507 g/cm³, and then compressed at 1650° C. for 4 h at 200 MPa in a hot isostatic method.

The samples are ground and polished to 2 mm thickness for a transmittance measurement. RIT values depending on the wave length were obtained: 300 nm: 86%, 600 nm: 85%, 700 nm: 84%, 1500 nm: 87%.

### Example 6

### Comparison Example

A MgOAl₂O₃ raw material with 398 ppm impurities is used, which was produced according to the hydrotalcite method. The following composition was determined according to ICP analysis:

Mg: 17.1%,

Al: 37.9%,
Na: 46 ppm,
K: 25 ppm,
Ca: 145 ppm,
Ti: 15 ppm,
V: 27 ppm,
Cr: 5 ppm,
Mn: 5 ppm,
Fe: 80 ppm,
Ni: 5 ppm,
Zn: 11 ppm,
Ga: 34 ppm,

O: Rest.

Specific surface area 20.1 m²/g.

540 g of raw material are stirred into 800 g of deionized water with 1.5% diammonium hydrogen citrate. This slurry is ground with an agitator ball mill (500 μm Al₂O₃-grinding beads) until an energy input of 1.0 kWh/kg is achieved. The following grain size distribution is then present: d90: 274 nm, d50: 156 nm, d10: 101 nm (measured with a Nanoflex measurement device from Microtrac), BET 58.0 m²/g.

The slurry is granulated as in Example 5. The comparably produced pellets with a net green density of 1.87 g/cm³ are presintered at 1410° C. for 2 h to 3.452 g/cm³ and then compressed at 200 MPa in a hot isostatic method.

The samples are ground and polished to 2 mm thickness for a transmittance measurement. No RIT values can be measured. The samples are opaque.

1.-7. (canceled)

8. A ceramic material comprising a metal oxide obtained by calcination of a hydrotalcite, wherein the ceramic material is used for producing transparent ceramics with an RIT value >40% at 300 nm, 600 nm, or 1500 nm wavelength of light.

9. The ceramic material according to claim 8, wherein the material for producing the transparent ceramic, which lie between 300 nm and 700 nm of the wavelength of light, have a deviation in RIT value of <10%.

10. The ceramic material according to claim 8, wherein the metal oxide contains between 100 and 500 ppm impurities.

11. The material according to claim 10, wherein the impurities are finely distributed at the atomic level in the metal oxide.

12. The ceramic material according to claim 8, wherein the metal oxide has a cubic crystal system.

13. The ceramic material according to claim 8, wherein the metal oxide with the cubic crystal system comprises a spinel.

14. A ceramic comprising the ceramic material of claim 8, wherein the ceramic is transparent.

15. The ceramic material according to claim 8, wherein the metal oxide contains between 100 and 200 ppm impurities.

16. The ceramic material according to claim 8, wherein the impurity is selected from the group consisting of Fe, Mn, Cr, V, Zn, Sn, Ti, Si, Zr, Ca, Na, K, Li, Y, Ni, Co and Cu.

17. A method for producing the ceramic material of claim 8 comprising the steps of:
calcining a hydrotalcite to obtain a metal oxide and form the ceramic material.

18. A method for producing a transparent ceramic material comprising the steps of:
calcining a hydrotalcite to obtain a metal oxide to form the ceramic material of claim 8, and
producing a transparent ceramic with said ceramic material with an RIT value >40% at 300 nm, 600 nm, or 1500 nm wavelength of light.

19. The ceramic material according to claim 12, wherein the metal oxide with the cubic crystal system comprises a member selected from the group consisting of a MG-Al-spinel, ZrO₂, an oxide of Y, an oxide of Al, and a mixed material of Al, N, and O.

20. The ceramic material according to claim 12, wherein the metal oxide is aluminum oxide in a cubic or non-cubic crystal structure.

21. The ceramic material according to claim 15, wherein the impurity is selected from the group consisting of Fe, Mn, Cr, V, Zn, Sn, Ti, Si, Zr, Ca, Na, K, Li, Y, Ni, Co and Cu.
